(19) United States
(12) Patent Application Publication
(10) Pub. No.: US 2025/0146310 A1
(43) Pub. Date: May 8, 2025

(54) INTELLIGENT CONSTRUCTION SYSTEM AND METHOD USING 3D PRINTING AND ADDITIVE MANUFACTURING

(71) Applicant: COSMOS 3D INNOVATECH INTERNATIONAL, S.L., PUERTO SAGUNTO (ES)

(72) Inventor: RUBÉN GARCIA MUÑOZ, QUARTELL (VALENCIA) (ES)

(21) Appl. No.: 18/838,116

(22) PCT Filed: Feb. 17, 2022
(86) PCT No.: PCT/ES2022/070079

§ 371 Date: Aug. 13, 2024

(51) Int. Cl. E04G 21/04; B33Y 30/00; B33Y 50/02

(52) U.S. Cl. CPC E04G 21/0463; B33Y 30/00; B33Y 50/02

(57) ABSTRACT

An intelligent 3D printing and additive manufacturing construction system including a printing machine connected to an external pumping device configured to feed a printing head of the printing machine with fresh concrete or mortar that is extruded through an extrusion nozzle of the printing head according to a layer pattern predefined in a digital file executable by a processor of the printing machine. Layers of the predefined pattern are applied continuously until the geometry configured in the digital file is printed, wherein the printing machine is configured as a mechanical system with a Cartesian configuration (X-Y-Z), having a continuous and modular Y axis, to allow the printing range to be adapted to constructions of different dimensions using the same printer. The equipment will be equipped with machine vision and artificial intelligence equipment to promote the autonomy and quality of the printing process.

### DESCRIPTION

Intelligent construction system and method using 3D printing and additive manufacturing

### TECHNICAL FIELD

The presented invention relates to a system for intelligent 3D printing and additive manufacturing using a variety of cementitious materials and has the purpose of reproducing 3D models previously designed as a CAD model.

### PRIOR ART

In terms of the state-of-the-art, several manufacturers of 3D printing-based building systems are known such as ICON Technology, Inc.; COBOD International A/S; and Yingchuang Building Technique Co. Ltd (WINSUN).

For example, document WO2020180323A1 thusly describes construction systems for building a structure on a base and methods related thereto. In one embodiment, the construction system includes a rail assembly configured to mount to the base. Furthermore, the construction system includes a mobile gantry on the rail assembly, configured to move along an initial axis with respect to the rail assembly. In addition, the construction system includes a mobile printing assembly on the gantry, configured to move along a second axis relative to the gantry. The second axis is orthogonal to the initial axis. The printing assembly is configured to deposit vertically stacked layers of an extrudable build material onto the base to build the structure. The gantry width along the second axis is configured to be adjustable with respect to the base.

WO2020131119A1 relates to methods for constructing a structure and a related non-transitory computer-readable medium. In one embodiment, the method includes (a) defining an initial vertical slice and a second vertical slice of the structure. A lateral cross-section of the structure within the initial vertical section is different from the lateral cross-section of the structure for the second vertical section. Furthermore, the method includes (b) depositing multiple vertically stacked initial layers of an extrudable build material using a printing assembly to form the initial vertical slice or slice. Furthermore, the method includes depositing multiple vertically stacked second layers of the extrudable build material on top of the initial portion or vertical slice using the printing assembly to form the second portion or vertical slice.

Compared to the aforementioned state-of-the-art, it is necessary to generate a construction system that is functional from an industrial point of view and to improve the quality of the finishes, guaranteeing modularity so that the product can be adapted to the user's needs, ensuring quality printing parameters as close as possible to construction standards. The system improves the working performance of existing technology on the market, allowing continuous 24/7 work, improves occupational safety and establishes an intelligent system based on machine vision techniques for process control and decision-making. This is achieved via the construction system that forms the subject of claim 1.

### EXPLANATION OF THE INVENTION

One object of the presented invention is an innovative construction system, based on 3D printing technology (FDM, Fused Deposition Modelling). The construction system is associated with a computer-implemented method that interprets the 3D model and prints it using a direct printing machine comprising a self-supporting structure presenting a Cartesian configuration and equipped with a printing head that deposits layers of concrete to create a three-dimensional structure in situ. This object is achieved using the 3D printing machine, the computer-implemented method and the constructive architectural design presented in the claims accompanying this specification.

For this purpose, the printing machine is configured as a structural mechanical system—preferably of steel construction—with a Cartesian configuration (X-Y-Z axes) that has a continuous and modular Y axis, in such a way that it makes it possible to adapt the printing range to constructions of varying dimensions using the same printer. It also includes a system of height-adjustable, width-adjustable rails for levelling and adjusting the Cartesian structure.

The 3D printing machine is also configured for direct printing without material accumulation devices in the head or hopper. The printing machine will have a double-chamber mixing, pumping and delivery system for special cement-based or clay-based mortars, allowing the printing of special materials such as micro-cements, organic mortars mixed with recycled plastics, clay-based mortars, natural fibres and others. This pumping system must be interconnected with the printer to send and receive information to and from the PLC.

The construction system that forms the subject of the presented invention is therefore configured to achieve optimum printing quality and high productivity due to drastic reduction of construction times through 24-hour printing with no downtime and an intelligent monitoring and control system.

The high construction speed of vertical structures makes it ideal for the manufacture of prefabricated structures in indoor environments with controlled environmental conditions. The construction of the structures of a 100m² house can be printed in a total time of less than 24 hours. The maximum printing speed of the construction system of the invention exceeds 1000 mm/second and is limited to 300 mm/second for safety reasons.

The feature that makes continuous 24-hour printing possible is the mirror-like duplication of the pumping system, with the pumping system and the human staff being interchanged from time to time.

Another differential factor of the invention lies in its intelligent printing system based on the implementation of machine vision and AI systems that allow process control and decision-making to be done by the system itself. It guarantees print quality autonomously and without human intervention, maintaining stable print parameters and minimising errors.

In addition, the construction system of the invention reduces the environmental impact compared to traditional or state-of-the-art construction systems. The construction system of the presented invention allows a 60% reduction in the use of materials and energy, since waste and carbon dioxide emissions into the atmosphere are reduced.

It is precisely because of all the above that the cost of printed construction is much lower than that of traditional construction. For example, the estimated cost is one-fifth that of traditional construction, also due in part to the fact that the personnel required to operate the system need not be specialists in construction, but only in the operation of the intelligent system itself, which is also simplified.

Finally, another key factor that the presented invention improves over traditional construction systems and those described in the state-of-the-art is occupational safety. The presented invention makes it possible to reduce the number of workers who perform the work; their presence may entail risks that are associated with the construction task itself and are subject to a high accident rate. The printing machine can be operated with only two or three operators who monitor the mixing, pumping and printing process, with practically no intervention in the actual construction process.

The advantages described are apparent from the claims accompanying the presented description. Throughout the description and claims, the word “comprises” and variants thereof are not intended to exclude other technical features, additives, components or steps. To those skilled in the art, other objects, advantages and features of the invention will follow in part from the invention and in part from its practice. The following examples and drawings are provided by way of illustration and are not intended to restrict the presented invention. Furthermore, the invention covers all possible combinations of particular and preferred embodiments indicated herein.

### BRIEF DESCRIPTION OF THE DRAWINGS

The following is a very brief description of a series of drawings which may aid better understanding of the invention and which relate expressly to an embodiment of the said invention, which is illustrated as a non-limiting example thereof.

FIG. 1 shows a perspective view of the printing machine assembly forming part of the 3D printing and additive manufacturing construction system that is the subject of the presented invention. FIG. 2 is a plan view of the printing machine from FIG. 1. FIG. 3 is the S-S section represented in FIG. 2. FIG. 4 shows the motion assembly on the X axis and the hose ducting attached to the X axis. FIG. 5 shows the columns that make up the motion assembly on the Y-Z axes. FIG. 6 shows the details of the connection of the X axis with the movable columns. FIGS. 7, 8 and 9 show the Y axis rail system and synchronous timing belt drive. FIG. 10 shows the details of the displacement elements on the Y-axis rails, together with the product hose and electrical wiring ducting. FIG. 11 shows the details of the Y axis column drive system. FIG. 12 shows the details of the Z axis column drive system. FIGS. 13, 14, 15 and 16 show the details of the printing head and its drive system on the X axis. FIG. 17 shows the details of the internal moving parts protection system and the printing head housing. FIG. 18 details the implemented functional scheme of the machine vision and artificial intelligence of the printing system. FIG. 19 shows the phases of the 3D printing process in schematic form. Finally, FIG. 20 shows the security device implemented in the system through a perimeter fence.

### Explanation of a Detailed Method to Realise the Invention

As has been indicated throughout the description, the presented invention relates to a system for intelligent 3D printing and additive manufacturing using a variety of cementitious materials and has the purpose of reproducing 3D models previously designed as a CAD model. The construction system is thus composed of a printing machine and a computer-implemented method that makes it possible to execute the automated extrusion of cementitious materials—preferably concrete—in layers according to a predefined digital model. In addition, the printer is equipped with an intelligent system to monitor the printing process and intervene if needed, both of which it can do autonomously.

The cementitious material, which in a particular non-limiting embodiment is fresh concrete or mortar, is thus pumped by an external pumping device into a printing head. Fresh concrete or mortar is extruded through a nozzle and placed according to a predefined layer pattern, and these layers are applied on top continuously until the desired geometry is printed.

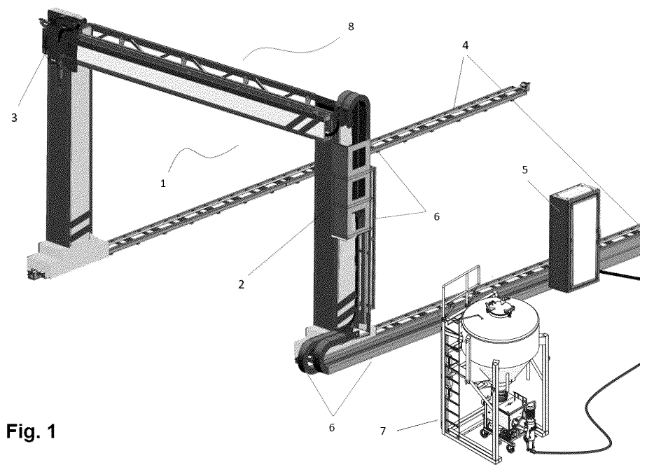

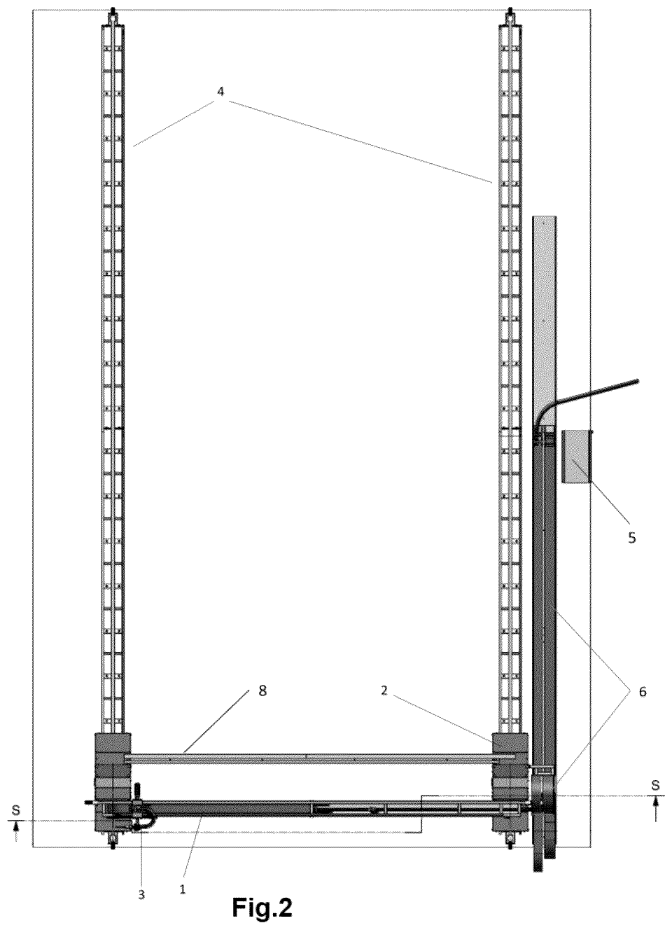

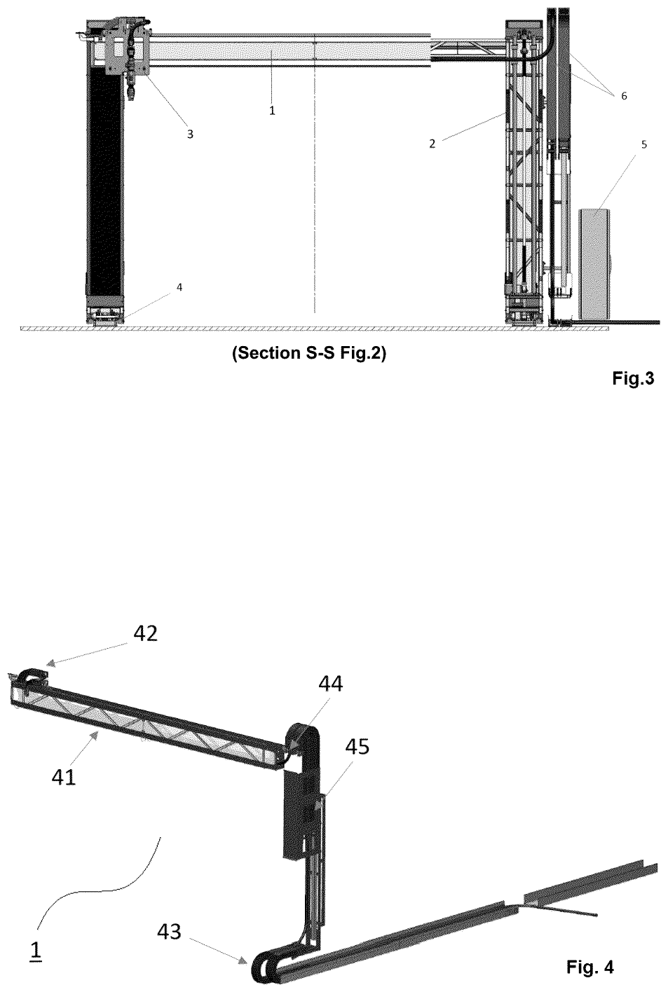

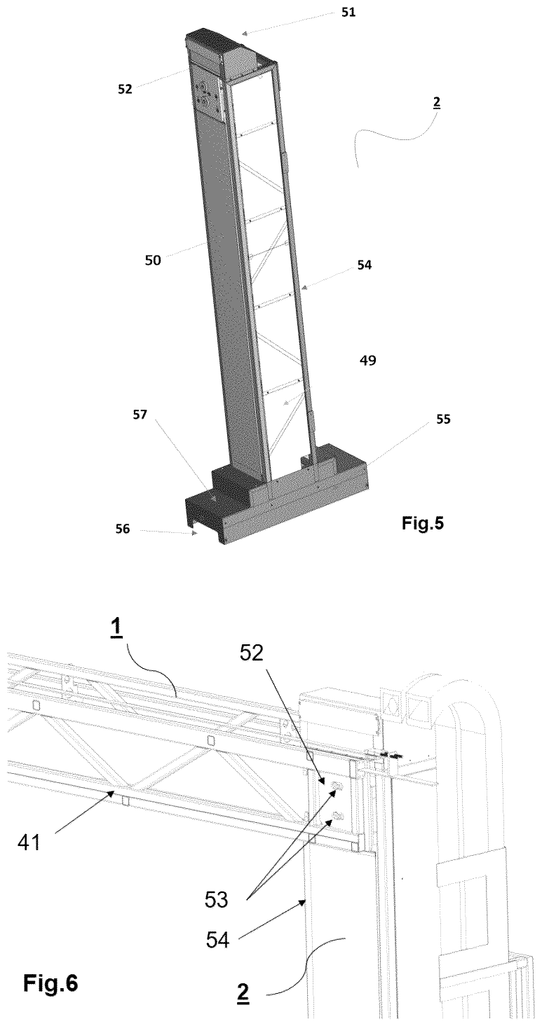

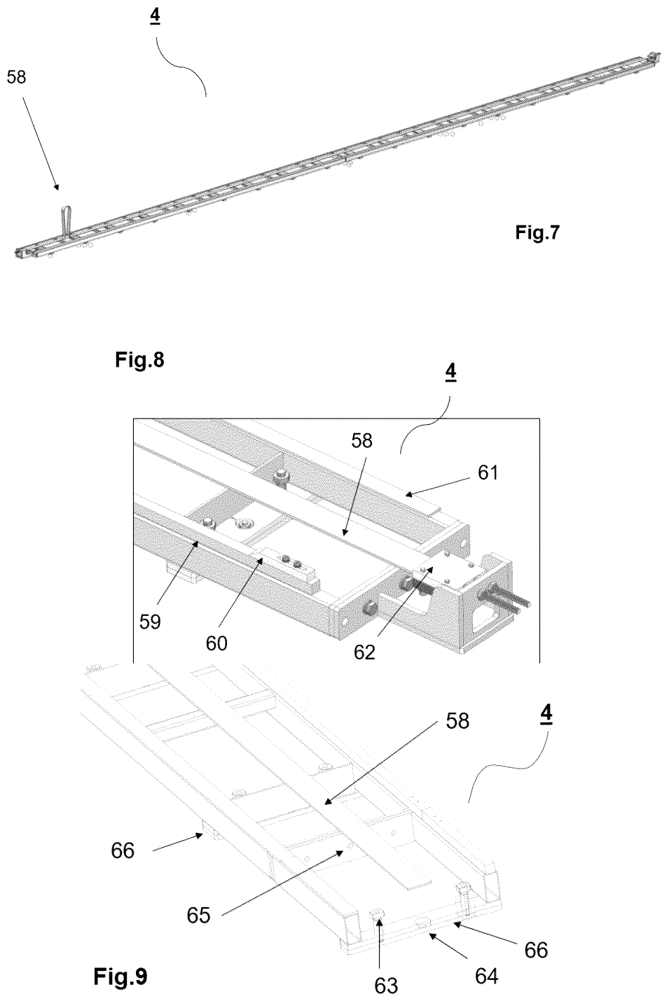

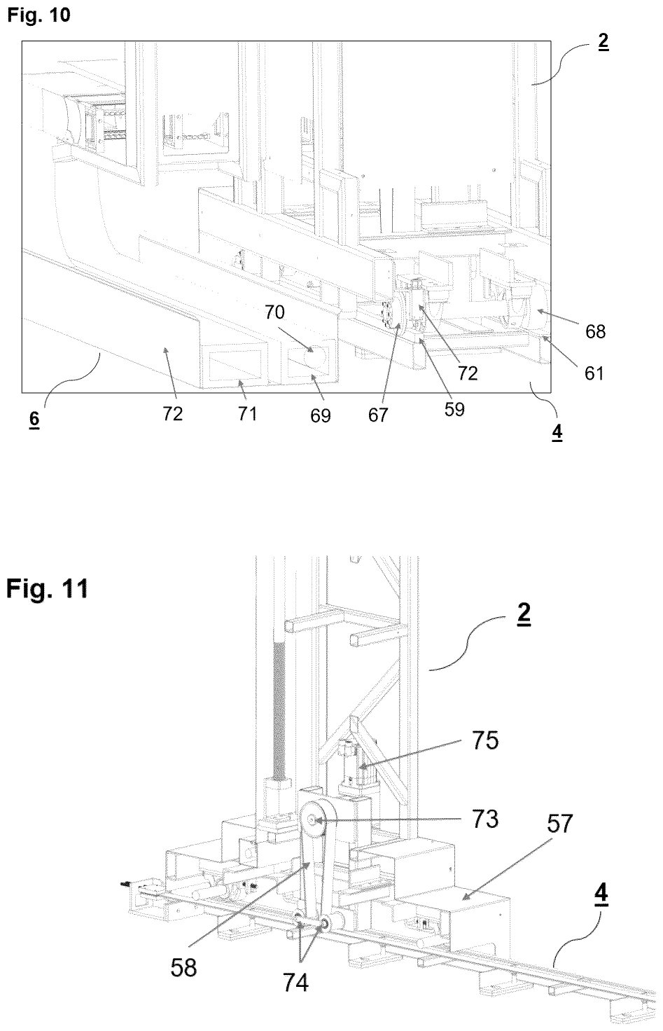

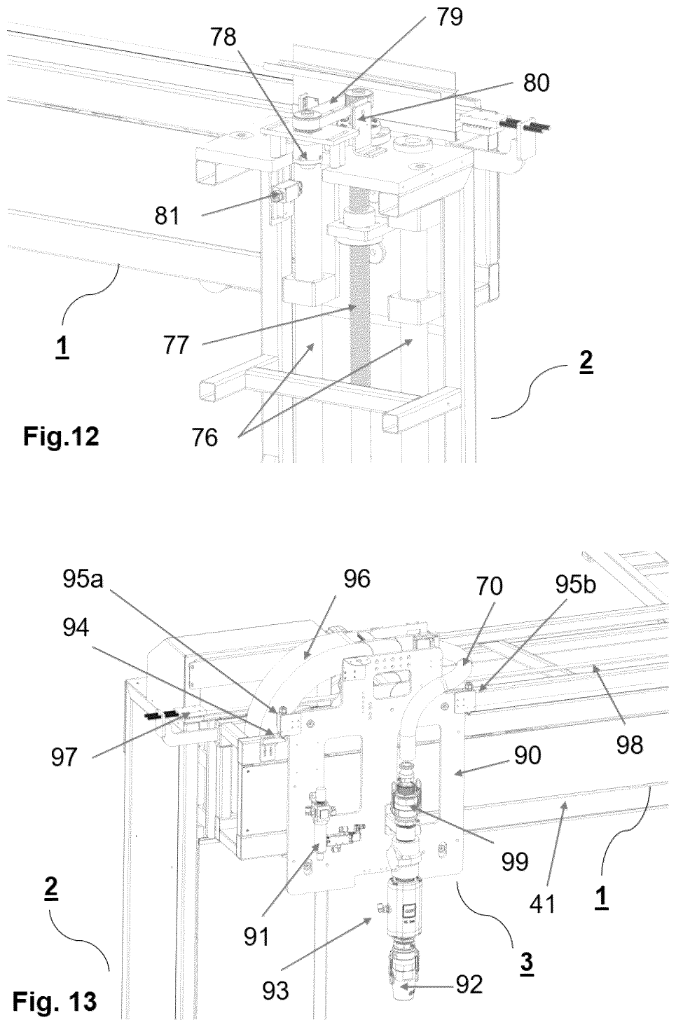

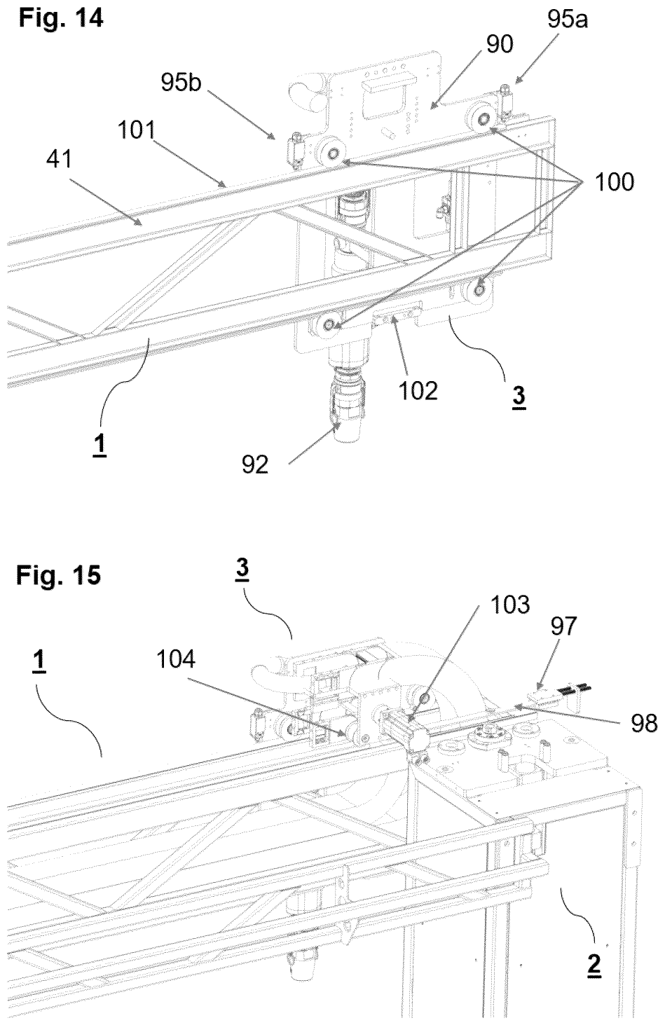

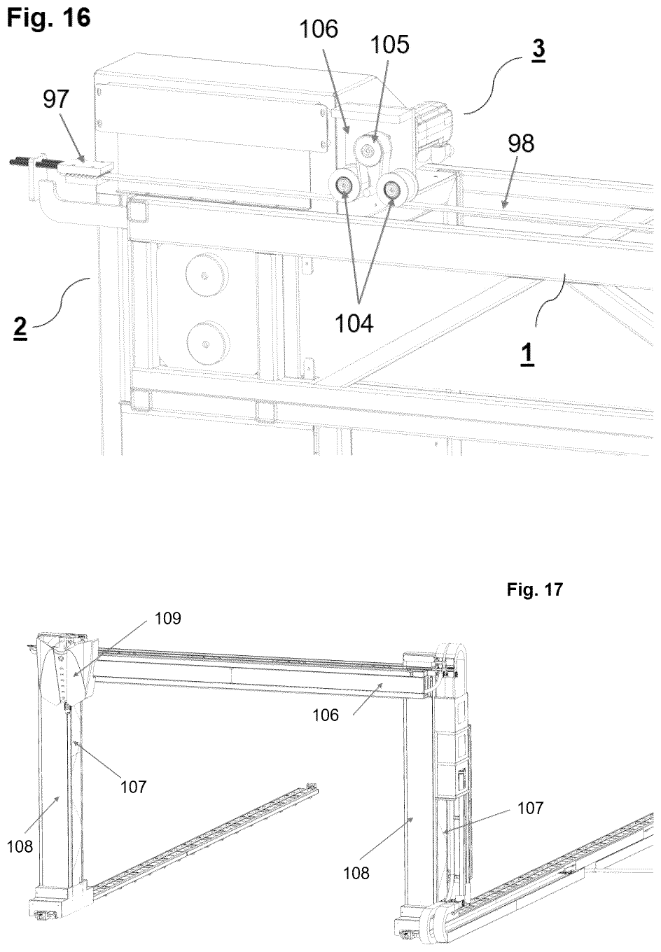

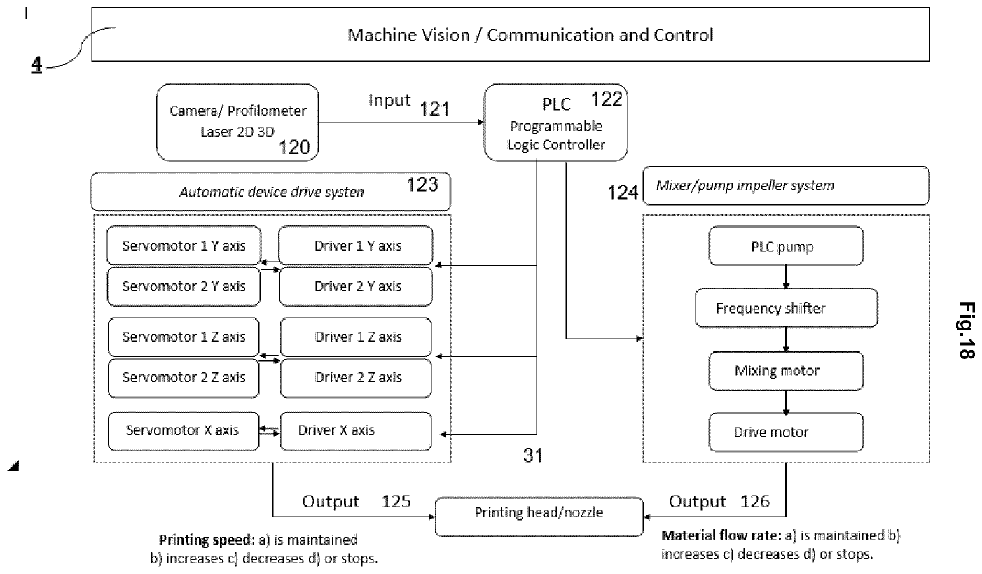

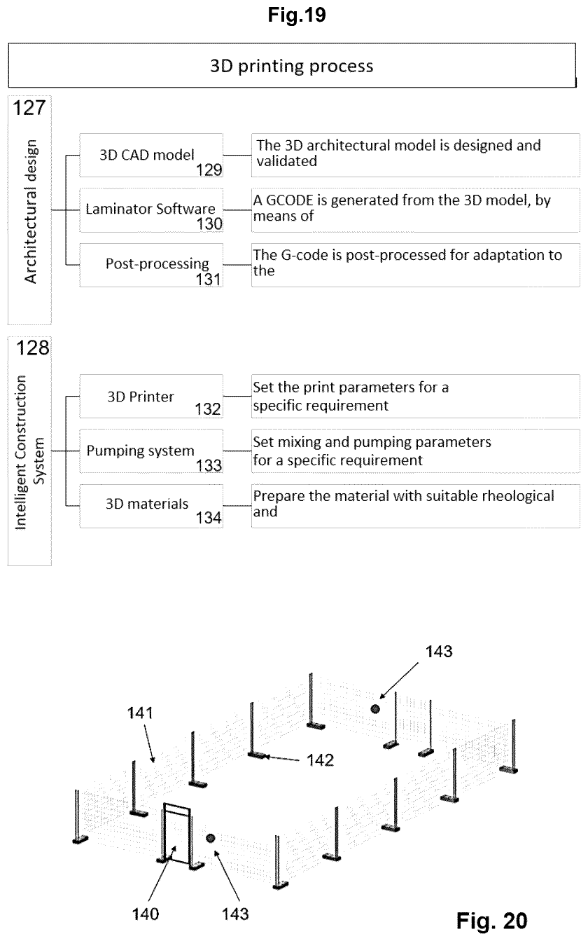

Referring to the figures, the printing machine is configured as a structural mechanical system—preferably of steel construction—with a Cartesian configuration (X-Y-Z axes) that has a continuous and modular Y axis, in such a way that it makes it possible to adapt the printing range to constructions of varying dimensions using the same printer. It also includes a system of height-adjustable, width-adjustable rails (4) for levelling the printing area. The printing machine can be seen in detail in FIGS. 1 to 3. FIG. 1 shows the main parts of the printing machine, which comprise the central cabinet, referenced as 5, where all the electrical and electronic control components (the PLC, servo controllers, etc.) of the automatic device are housed. The X axis of the structural profile, referenced as 1 and made of steel, is also shown in detail in FIGS. 13,14,15, and 16 and is where the printing head (3) slides. Other parts are the movable steel columns, referenced as 2 in the figures, which form the Z axis and shown in detail in FIGS. 5, 11 and 12. FIGS. 7, 8, 9 and 10 show the details of the construction system of the rails (4) that determine the Y axis displacement. Parallel to the structural profile (1) of the X axis and in the upper part of the columns, there is another steel structural axis (8) through which the electrical wiring of the installation runs, which is installed between the two vertical columns (2) that make up the Y-Z axis.

FIGS. 4 and 13 show the assembly that facilitates movement along the X axis, which is formed by a structural profile section (41) of the X axis, along which the printing head (3) moves by means of a synchronous-transmission toothed belt (98), which is fastened at its ends via tensioners (97) to the structural profile (41) of the X axis. This assembly also incorporates the channelling elements for the hoses and electrical wiring of the machine (45) in such a way that movements along the different axes are made possible by means of an initial plastic chain assembly (43) on the Y axis, as well as a second plastic chain assembly (42) on the Z axis, maintaining the flow of material in a constant manner. The tray through which the product hoses will run will be placed on the structural profile (41) of the X axis.

The movable column assembly that facilitates movement along the Y-Z axes is shown in FIG. 5. This assembly is composed of a base comprising a channel (56) with self-guiding support wheels on the rails (4) and enclosed on both sides by a pair of front and rear protective panels (57) and a pair of side protective panels (55). A welded structural profile column (54), equipped with a protective textile screen (50) and plastic side shields (49) to prevent direct contact with the guided roller drive system that moves the X axis mounting plate (52), so that the X axis structural profile (41) can move between two end points of the structure (54), generating the Z movement of the printing head (3).

For the assembly and adjustment of perpendicularity between the columns (54) (Z axis), the structural profile (41) (X axis) and the floor guides (Y axis), the mounting plate (52) employs a 2-bolt connection system with slot holes (53) that will allow the correct adjustment of parallelism between columns and perpendicularity with the floor guides. This detail may be observed in FIG. 6.

Movement along the Y axis is executed via the rails (4), which are modular profiles—preferably made of steel—that can be joined together to form a continuous leveling surface along which the columns (2) that make up the Y-Z assembly shown in FIGS. 5 and 6 move synchronously. The clamping and tensioning brackets (62) are mounted at both ends of the guide, anchored to the same guide upon which is mounted a synchronous drive timing belt (58) for synchronized movement of the columns 2. The whole assembly can be levelled to absorb any deformation of the ground where the printer is installed.

FIGS. 7, 8 and 9 show the details of the Y axis synchronous belt 58. This belt requires a working tension provided by a pair of tensioners (62) located at the end of the rails.

FIG. 9 shows the anchoring and levelling system of the guides that will ensure the flatness of the assembly and the proper adjustment of the distance between columns. The maximum printing length on the Y axis is variable, it will be defined by the length of the rails and sections can be added or removed by connecting rails with screws (65). The flatness of the whole assembly is achieved by means of a double-locking screw system (63) that makes it possible to regulate and fix two plates (66) at a height; these plates are placed along the whole length of the guide. This height-adjustable double plate system (66) allows localised levelling of the rails in height, acting in a punctual manner on the different differences in height from the floor. Ground fastening and the adjustment of distance and parallelism between the rails is achieved by means of metal anchors (64) mounted on smooth holes and located along the rails.

FIGS. 8 and 10 show the self-guiding wheel support guides of the assembly or columns shown in FIG. 5. The guide has a flat support profile (61) on which a metal wheel with bearings (68) rests and a rectangular profile (59) on which a U-shaped slotted wheel (67) is fitted. The physical limit switches or stops (60) will be mounted on this profile, located at the 4 ends of the rails and where the limit switches or position switches will act. The limit switches or position switches (72) are mounted on the carriage base; they are the sensors that act on the stops (60) fixed to the rails and detect the position of the moving assembly by means of this mechanical actuation of the Y axis. These limit switches are mounted on the X, Y and Z axes and allow the adjustment of the limits of the printing area of the machine along these axes. There are 4 limit switches on the Y axis (72), two units on the X axis (95) and another four on the Z axis (81).

FIG. 10 also shows the assembly comprising two plastic chains that allow the channelling for the product hoses (69), connected to the printing head and electrical wiring (71) of the machine (45) in such a way as to enable the free movement of the hoses (70) along the different axes as well as movement possibilities for the printing head. The chains will be placed on the floor on metal trays (82) with a guide function.

FIG. 11 shows the details of the drive system for moving the set of columns (2) on the rails (4) in the Y axis. The assembly uses servomotors (75) with a 90° transmission that transmits motion to a gear (73) coupled to a synchronous timing belt (58) mounted on rails (4). The system uses two tension pulleys (74) that ensure the correct adjustment and synchronism of the movement generated by the motors. The system is located at the bottom of the movable columns (2) and is protected by the front protective panels (57) and the side protective panels (55).

FIG. 12 shows the detail of the drive system for the displacement of the X axis structural profile assembly (1) on the columns (2 on the Z axis. The assembly uses servomotors (78) that transmit motion to a vertical spindle (77) via a toothed belt (79). This belt is monitored by a safety sensor (80) which detects belt breakage and would act in conjunction with the servomotor emergency brake (78) to prevent uncontrolled dropping of the X-axis (1). The entire assembly is internally guided with two ground steel columns (76). The assembly has two limit switches or position switches (81), which are fixed to the upper and lower parts of the column, upon which the inner part of the anchor plate to the X axis acts mechanically.

FIGS. 13, 14, 15 and 16 show the printing head (3) in detail. Specifically, the printing head (3) is mounted on a plate (90) that fixes the printing head to the structural profile (41) of the X axis by means of four self-guided wheels (100) that are encased in a metal profile (101) arranged on the metal frame 41. The fixing plate (90) is provided with a system for adjusting (102) the distance between the self-guiding wheels (100) to promote the correct movement of the assembly.

The drive system is at the rear of the printing head (3) and consists of a servomotor (103) mounted on a bracket (106) anchored to the printing head fixing plate (90). The movement of the head is accomplished by the actuation of the servomotor (103) which transmits the movement to a gear (105) coupled to the synchronous timing belt (58) mounted on the structural profile of the X axis (1). The system uses two tension pulleys (104) that ensure the correct adjustment and synchronism of the movement generated by the motor.

The spindle drive system, like the Y axis rails, has a synchronous timing belt (58) which is fastened and tensioned at its ends by means of special clamps (97).

The fixing plate (90) has two limit switches or position switches fixed on the left side (95a) and on the right side (95b) of the plate, which act mechanically on the stops (94) fixed to the two ends of the X axis.

At the front of the fixing plate (90), the printing head (3) comprises the final injection section, which is composed of an extrusion nozzle (92) which is configurable to different diameters, a shut-off valve (93) for opening and closing the passage of the material towards the extrusion nozzle, a connector (99) with the material hose (70), and lastly a pneumatic regulator (91) configured to operate the shut-off valve.

FIG. 18 shows the schematic of the machine vision and intelligence system implemented in the machine for inspection and control of the printing process; it is composed of several elements:
An artificial intelligence programme or programmes, consisting of a set of instructions stored in memory and executable by a programmable logic controller (PLC)
An optical image acquisition device or laser profilometer mounted on the fixture plate (30),
Means of communication, recording and analysis,
A programme or programmes composed of multiple instructions which, when executed by the programmable logic controller, enable a construction defect to be detected.

The machine vision and artificial intelligence system has cameras/profilometer (120) arranged on the printing head (4) in such a way that they generate and send an INPUT (121) which is sent to the PLC (122) continuously and in real time during printing. Through software and decision algorithms installed in the PLC, we can detect existing defects in the printing bead and detect defective surfaces, such as any lack or excess of material and any dimensional deficiencies of the bead. This system allows error detection, communication and autonomous decision-making in real time during printing. Using control algorithms, the PLC will act based on two basic printing parameters and generate two simultaneous and coordinated OUTPUTS during the printing process.

Firstly, a signal will be sent to the servomotor drivers and in turn to the servomotors themselves that control the automatic device drive system (123). The OUTPUT (125) will modify the speed of the printing head/nozzle (31) depending on the results of the algorithm and the images captured by the profilometer: it will maintain the speed if the result is correct, increase the speed if the bead width is above the maximum tolerances, reduce the speed if the bead width is below the minimum tolerances or stop in the event that a defect or discontinuity exceeds the maximum tolerances.

Secondly, a signal will be sent to the PLC of the material mixing and delivery pump (124). The OUTPUT (126) will use a frequency inverter to modify the power of the material mixing and discharge motors, modifying the nominal flow rate of the pumped material. Depending on the results of the algorithm and the images captured by the profilometer, different decisions will be taken: the drive speed (and therefore the flow rate) will be maintained if the result is correct, the speed will be increased if the width of the bead is below the minimum tolerances, the speed will be reduced if the width of the bead is above the maximum tolerances or stopped in the event that a defect or discontinuity exceeds the maximum tolerances.

The printing head and nozzle (31) will be subject at all times to changes in the speed of movement (mm/s) and flow rate (I/h) of the deposited material during printing, which will allow a high level of autonomy and print quality.

The correct implementation of the two OUTPUTS in a simultaneous and coordinated manner will be the basis of the system's artificial intelligence system. This system provides the equipment with advantages such as error correction during the printing process, quality optimisation, reduction of waste product and an effective, optimised printing process.

Furthermore, the printing head (3) is equipped with two IP cameras set up to allow viewing of the printing process, specifically the deposition of the bead from the extrusion nozzle (31) and from the top of the printer. Its function is to allow visual monitoring by the operator of the print quality, which is vital when the printing head (3) reaches a certain height where the operator does not have a direct view of the bead.

FIG. 19 shows the printing process based on the implementation of new architectural- constructive designs with the additive manufacturing intelligent construction system which forms the object of this invention. The process begins with the creation of an architectural design (127) that will be translated into a 3D CAD model (129) which will include the specific requirements (habitability, resistance, among others) and will comply with a standardised construction code. These models must be validated by computer model testing prior to implementation.

The 3D model will be sent to an open source lamination software package (130) specific to additive manufacturing technologies, which will generate a G-CODE or code with the commands for execution by the 3D printer. Finally, prior to printing, the G-CODE must be post-processed (131) in order to adapt the construction solution orders to the peculiarities of our system.

Once the initial phase has been successfully completed we have a G-CODE that will be read and interpreted by the intelligent building system (128). The printing process starts with the configuration of specific parameters of the 3D printer equipment (132). Printing plans and parameters such as nozzle diameters, nozzle sections and hose diameters, etc. will be adjusted. Some parameters such as the printing nozzle diameter will define the bead width, nozzle printing speed, printing area length and layer height, among others.

Next, we must prepare the parameters of the pumping system (133) to ensure a constant flow of material during printing, such as selection of the pump stator and rotor that defines the flow, selection of the primary mixing shaft, impulsion blades, etc. In turn, the pumping system must be configured to achieve correct mixing and pumping to ensure the required flow at all times and thereby guarantee the quality and continuity of the printing. Other parameters of the pumping system are the type of material used, the amount of water in the mixture, selection of the mixing dosing shaft, selection of the rotor and drive stator, among others.

These parameters will ensure that the cementitious material is pumped through the pumping system that has been configured to perform the mixing of materials and impelled following the orders that are set in the G-CODE and are read by the PLC and executed by the printer. The deposition of the material will reach the extrusion nozzle (31) attached to the printing head (3). The material feeding system is connected through high pressure hoses to transport the materials to be applied. The hoses are in sections in order to extend the printing range and to allow easy cleaning,

Another essential factor in the system is the 3D material (134), which must have rheological and physical properties to guarantee the correct extrusion and the desired result of the construction solution.

Additionally, automated processes, such as the purging and cleaning process, are implemented to avoid material blockages in the hoses with material purging processes through the extrusion nozzle (31), either after a pause in the printing process or if a preset maximum stop time has been exceeded. In this purging process, printing stops and the printing head (3) moves to the cleaning zone set aside for this purpose, where it begins to purge material. Once the purge process begins, the pumping system will purge the printing head (3) for a preset time. Finally, the printing head (3) is positioned at the last point where it stopped and resumes printing.

Finally, FIG. 20 shows the safety system implemented in the machine for accident prevention consisting of a perimeter fence comprising multiple metal panels (141), pedestals (142) and an access gate (140). The printing area through which the machine is moving is physically delimited in order to monitor and prevent involuntary uncontrolled access by any person, thus avoiding any situations of risk for any personnel outside the installation who are not working with the machine while it is in motion. In the event that the safety door is opened, the system is equipped with a magnetic detection sensor connected to the Programmable Logic Controller or PLC 5 which will cause the printing machine to automatically enter a safe state, limiting its maximum speed and acceleration along all its axes to a set safe speed and acceleration. In addition, the fence has mushroom-type emergency stop buttons (143) located at both ends, allowing an operator within the printing area to stop the machine at any time.

What is claimed is:

1. An intelligent building system using 3D printing and additive manufacturing comprising:
a printing machine comprising:
a printing head having an extrusion nozzle, and
a programmable logic controller,
wherein the printing machine is connected to an external pumping device configured to feed the printing head with fresh concrete or mortar to be extruded through the extrusion nozzle according to a predefined layer pattern in a digital file executable by the programmable logic controller of the printing machine;
wherein the printing machine is configured to continuously apply the layers of the predefined pattern until the geometry configured in the digital file is printed,
and wherein the printing machine comprises a self-supporting structure configured as a mechanical system with a Cartesian configuration (X-Y-Z), and wherein the printing machine further comprises:
a X axis structural profile made of steel, wherein the printing head is configured to slide across the X axis structural profile;
movable steel columns which form the Z axis, wherein the movable steel columns are connected to the X axis structural profile; and
a continuous and modular Y axis, configured to adapt the printing range to constructions of different dimensions using the same printing head, wherein the movement along the Y axis is defined via rails, wherein the rails are modular profiles joined together, and wherein the rails are height-adjustable and width-adjustable for levelling the printing area so as form a continuous levelable surface over which the columns move synchronously;
wherein the system also comprises:
machine vision and artificial intelligence resources comprising at least one camera and/or a profilometer arranged on the printing head configured to generate and send an input signal to the programmable logic controller continuously and in real time during printing; and wherein the programmable logic controller comprises a programme or programmes configured to detect existing defects in the print bead and detect defective surfaces.

2. The intelligent building system according to claim 1 further comprising an assembly configured to facilitate movement on the X axis, the assembly comprising:
an X axis structural profile section, wherein the printing head is configured to move on the of the X axis structural profile section; and
a synchronous drive belt to move the printing head on the X axis structural profile section, wherein the synchronous drive belt comprises two ends attached to the X axis structural profile.

3. The intelligent building system according to claim 2 wherein the assembly for facilitating movement in the X axis comprises channelling elements for the hoses and electrical wiring of the printing machine, such that movements in the different axes are made possible by an initial chain assembly in the Y axis as well as a second chain assembly in the Z axis, maintaining a constant material flow.

4. The intelligent building system according to claim 1 comprising an assembly configured to facilitate movement along the Y-Z axes, the building system further comprising a base comprising a channel with self-guiding support wheels arranged on the rails and enclosed on both sides by a front panel and a side panel.

5. The intelligent building system according to claim 4 wherein the assembly is configured to facilitate movement in the Y-Z axes, wherein on the base a column fitted with a protective screen is provided, wherein the column is structured as a guide for an X axis mounting plate, such that the X axis structural profile can move between two end points of the structure, generating the Z axis movement of the printing head.

6. The intelligent building system according to claim 1 wherein the columns comprises an assembly configured to facilitate movement along the Y-Z axes.

7. The intelligent building system according to claim 6 wherein at both ends of the guideway are mounted the clamping brackets anchored to the same guideway, and on which is mounted a toothed belt drive for the synchronised movement of the columns, and wherein the whole assembly can be levelled to absorb any deformation of the ground where it is mounted.

8. The intelligent building system according to claim 1 wherein the printing head is mounted on a printing head attachment plate to the X axis structural profile by means of self-guiding wheels, and wherein at the rear of the printing head the drive system is set up using a synchronous toothed belt drive configured for the displacement thereof with respect to the X axis.

9. The intelligent building system according to claim 8 wherein on the front side of the printing head attachment plate, the printing head comprises injection resources which comprise the extrusion nozzle, a pneumatic shut-off valve for opening and closing the material passage to the extrusion nozzle, a connector with the material hose and finally IP cameras for monitoring and controlling the quality of the material deposited by the extrusion nozzle.

10. The intelligent building system according to claim 1 wherein the printing head comprises machine vision and artificial intelligence equipment in addition to cameras configured to monitor and control the printing process, specifically the quality of the bead deposition from the extrusion nozzle.

11. The intelligent building system according to claim 1, further comprising a security system comprising a perimeter fence, formed by multiple removable panels with an access gate, for physically enclosing the secure working perimeter through which the printing machine is moving.

12. A computer-implemented method configured to be executed within the building system according to claim 1 comprising:
a process of referencing absolute and relative zero by manually moving the X, Y and Z axes.
a material loading process comprising an initial stage of lubrication of the hose system and a second stage of material delivery from the pump to the extrusion nozzle, including a stepwise reduction of water until the ideal rheology of the material is reached and extruded through the nozzle;
a printing process in automatic mode comprising the loading of a digital file with a three-dimensional model capable of being printed by the printing machine; and
comprising a process of detecting existing defects in the print bead and detecting defective surfaces by means of machine vision and artificial intelligence means comprising at least one camera and/or a profilometer set up in the printing head and configured to generate and send an input signal to the programmable logic controller continuously and in real time during printing.

13. The method according to claim 12 comprising a process of purging the material from the extrusion nozzle either manually or after a pause in the printing process when a preset maximum stop time has been exceeded.

14. The method according to claim 13 wherein in the process of purging material, printing is stopped and the printing head moves to the area established for such a purpose where it begins to purge; and wherein once the purging process begins, the pumping system will purge material through the printing head into a special container for a preset time; and wherein once purged, the printing head will return to the last point where it stopped and resume printing.

15. An intelligent building system using 3D printing and additive manufacturing comprising:
a printing machine comprising:
a printing head having an extrusion nozzle, and
a programmable logic controller,
wherein the printing machine is configured to be connected to an external pumping device configured to feed the printing head with fresh concrete or mortar to be extruded through the extrusion nozzle according to a predefined layer pattern in a digital file executable by the programmable logic controller of the printing machine;
where the printing machine is configured to continuously apply the layers of the predefined pattern until the geometry configured in the digital file is printed,
and where the printing machine comprises a self-supporting structure configured as a mechanical system with a Cartesian configuration (X-Y-Z), wherein the printing machine comprises:
a X axis structural profile made of steel, wherein the printing head is configured to slide across the X axis structural profile;
movable steel columns which form the Z axis, wherein the movable steel columns are connected to the X axis structural profile; and
a plurality of rails comprising profiles joined together to form a continuous and modular Y axis, configured to adapt the printing range to constructions of different dimensions using the same printing head, and wherein the rails are height-adjustable and width-adjustable for levelling the printing area so as form a continuous levellable surface over which the columns move synchronously.

16. The intelligent building system according to claim 15, wherein the plurality of rails comprises two plates and a double locking screw system for adjusting the height of the plurality of rails.

17. The intelligent building system according to claim 15, wherein the plurality of rails comprises slotted holes for receiving metal anchors to be anchored to the ground to adjust a distance and parallelism between the rails of the plurality of rails.

18. The intelligent building system according to claim 15, further comprising a driving system for moving a set of columns on the rails in the Y-axis, wherein the driving system comprises a Y-axis synchronous belt.

19. The intelligent building system according to claim 18, wherein the driving system comprises a pair of tensioners located at the end of the plurality of rails for providing a working tension to the Y-axis synchronous belt.

20. The intelligent building system according to claim 15, further comprising an assembly configured to facilitate movement on the X axis, the assembly comprising:
a X axis structural profile section, wherein the printing head is configured to move on the of the X axis structural profile section; and
synchronous drive belt to move the printing head on the X axis structural profile section, wherein the synchronous drive belt comprises two ends attached to the X axis structural profile.
